(19) United States
(12) Patent Application Publication
(10) Pub. No.: US 2009/0245968 A1
(43) Pub. Date: Oct. 1, 2009

(54) NUT ATTACHING AN AIRCRAFT WINDSHIELD AND DEVICE FOR ATTACHING AN AIRCRAFT WINDSHIELD INCORPORATING SAID NUT

(75) Inventor: Guy Cavailles, Leguevin (FR)

Correspondence Address: YOUNG & THOMPSON, 209 Madison Street, Suite 500, ALEXANDRIA, VA, 22314, US

(73) Assignee: AIRBUS FRANCE, TOULOUSE (FR)

(21) Appl. No.: 12/294,429

(22) PCT Filed: Feb. 26, 2007
(86) PCT No.: PCT/FR07/50848

§ 371 Date: Sep. 25, 2008

(30) Foreign Application Priority Data
Mar. 31, 2006 (FR) 06 51128

(51) Int. Cl. F16B 37/04

(52) U.S. Cl. 411/181

(57) ABSTRACT

A nut for the attachment of an aircraft windshield interposed between two elements kept assembled by at least one connecting element that includes a screw and the nut includes two parts, a first part called a body that has a threaded bore for the threaded stem of the screw, and a second part called a base that can be integrated with one of the windshield holding elements. The body and the base have cooperating shapes to prevent the body from rotating relative to the base along the axis of the bore of the body. The body, at one of its ends, includes a surface that can be in contact with the base, whereby the surface has at least one protuberance that projects relative to the surface in the direction of the axis of the bore that can work with a pattern that is provided at the base.

This invention relates to a nut for attaching an aircraft windshield as well as a device for attaching an aircraft windshield that incorporates said screw.

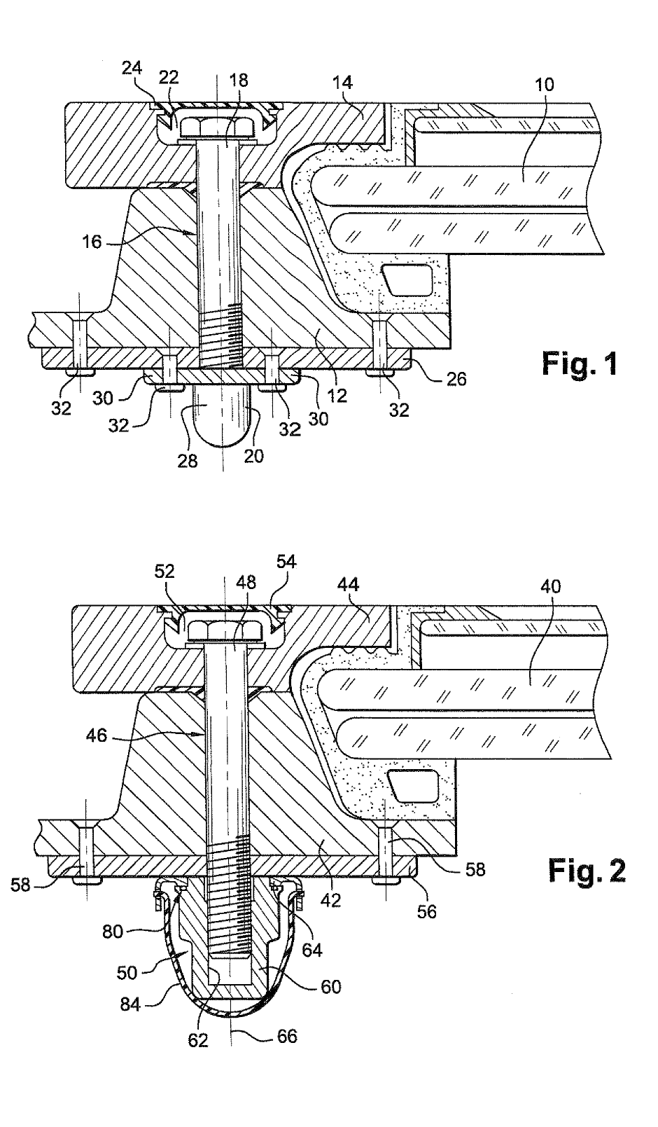

Shown at 10 in FIG. 1 is a glass of an aircraft windshield that is connected to the structure 12 of the aircraft by means of a frame or at least one flange 14 that is connected to said structure 12 by means of connecting elements 16, whereby the peripheral edges of said windshield glass 10 are interposed and clamped between the structure 12 and the flange 14.

In addition, sealing means are generally provided around the edges of the windshield, interposed between the structure and the windshield and/or between the flanges and the windshield.

The attachment elements 16 each comprise a screw 18 with a hexagonal head and a nut 20. Each screw 18 passes through the flange 14 and the structure 12, whereby the head rests against the outside surface of the flange 14 and is placed inside a housing 22 that is provided at the outside surface of said flange 14. A plug or cap 24 is provided for closing said housing 22 and for limiting disruptions of the air flows at the surface of the aircraft fuselage.

A nut 20 is riveted onto a small nut-support plate 26, itself riveted onto the structure. This nut 20 allows pressure-sealing.

This small nut-support plate 26 makes it possible to obtain a better distribution of the tightening forces on the structure and to limit the anchoring points on said structure, whereby a small plate generally supports several nuts 20.

As illustrated in FIG. 1, the nut 20 comprises a threaded bore 28 that makes possible the screwing of the screw 18 and two wings 30 that extend in a plane that is approximately perpendicular to the longitudinal axis of the bore, at one end of the nut, and placed on both sides of said bore 28. The wings 30 form a support surface that can be flattened against the structure 12 or a small nut-support plate 26.

For the initial mounting, the small nut-support plates 26 as well as the nuts 20 are connected to the structure 12 by means of rivets 32. Next, the windshield glass 10 that is equipped with sealing means is placed in the frame that is provided in the structure, and then the flange(s) 14 are placed around the edges of the glass 10. Next, the screws 18 are screwed into the riveted nuts 20. For this purpose, the head of the screw is manipulated by any suitable means, such as, for example, a key, whereby the connection by means of rivets 32 between the nuts 20 and the structure 12 prevent said screws from rotating during the screwing and make it possible to tighten said screws 18.

This assembly makes it possible to achieve a reliable and strong attachment of the windshield. To remove the glass from the windshield, it is advisable to unscrew the screws 18 so as to disengage the flange or flanges from the structure and to release said glass 10. This operation is considered quick and easy.

However, it may prove long and tedious when a nut is damaged, in particular when said nut and the associated screw are corroded.

Actually, it is then advisable to remove the nut 20 that is riveted onto the small plate 26 that is itself riveted onto the structure, whereby said small plate should also be removed to be able to rivet a new nut there.

This operation is relatively long and difficult to accomplish, in particular due to the lack of access and the complex environment inside a cockpit.

The windshield-changing time, however, has to be as short as possible so as to limit the servicing time and the aircraft downtime in order to avoid disadvantaging the airline by limiting the time of use of said aircraft. This problem is heightened if the replacement is to take place during a stopover of the aircraft, since it may result in a delayed flight or even a cancellation.

Also, the purpose of this invention is to eliminate drawbacks of the prior art by proposing a nut for the attachment of an aircraft windshield facilitating the change of said nut when the latter is damaged, in particular during the changing of the windshield.

For this purpose, the invention has as its object a nut for the attachment of an aircraft windshield that is interposed between two elements that are kept assembled by at least one connecting element that comprises a screw and said nut, whereby said nut comprises two parts, a first part that is called a body that comprises a threaded bore that can work with the threaded stem of the screw, and a second part that is called a base that can be integrated with one of the windshield holding elements, the body and the base having cooperating shapes that make it possible to prevent the body from rotating relative to the base along the axis of the bore of the body, characterized in that the body, at one of its ends, comprises a surface that can be in contact with the base, whereby said surface comprises at least one protuberance that projects relative to said surface in the direction of the axis of the bore that can work with a pattern that is provided at the base.

This solution makes it possible to obtain a reliable attachment while limiting the service time during the removal using a two-part nut.

Other characteristics and advantages will emerge from the following description of the invention, a description that is provided only by way of example, taking into account the accompanying drawings in which:

FIG. 1 is a cutaway illustrating a device for attaching a windshield according to the prior art,

FIG. 2 is a cutaway illustrating a device for attaching a windshield according to the invention,

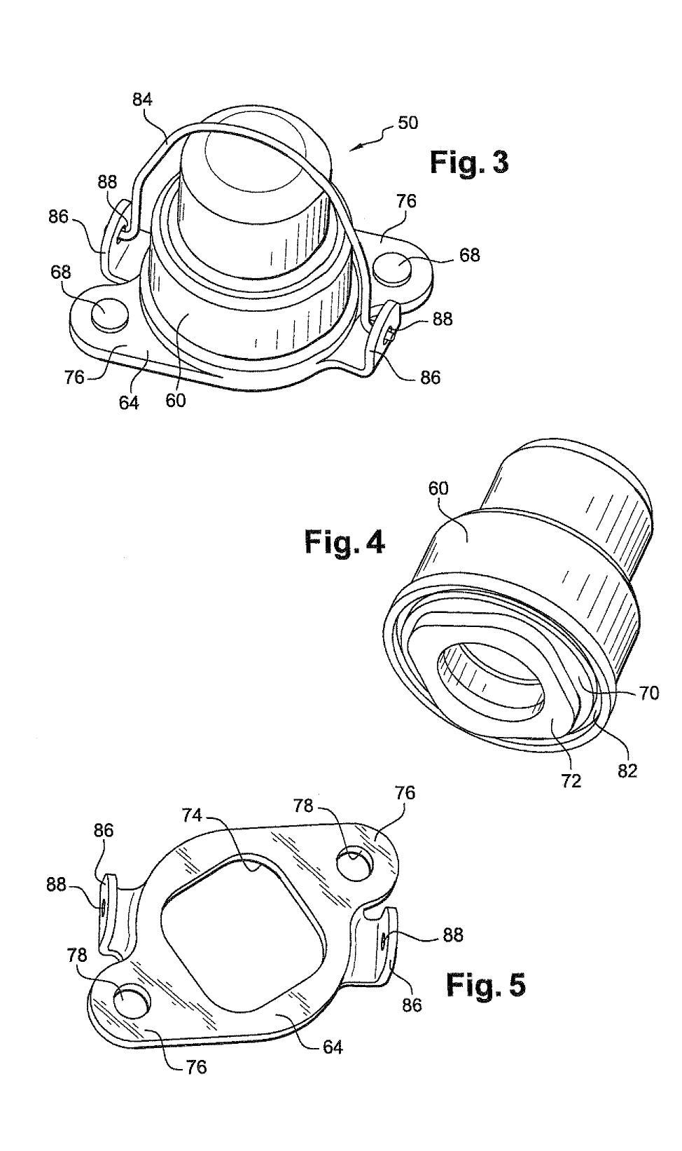

FIG. 3 is a perspective view of a nut for attaching a windshield according to the invention,

FIG. 4 is a perspective view illustrating the body of a nut according to the invention,

FIG. 5 is a perspective view illustrating the base of a nut according to the invention,

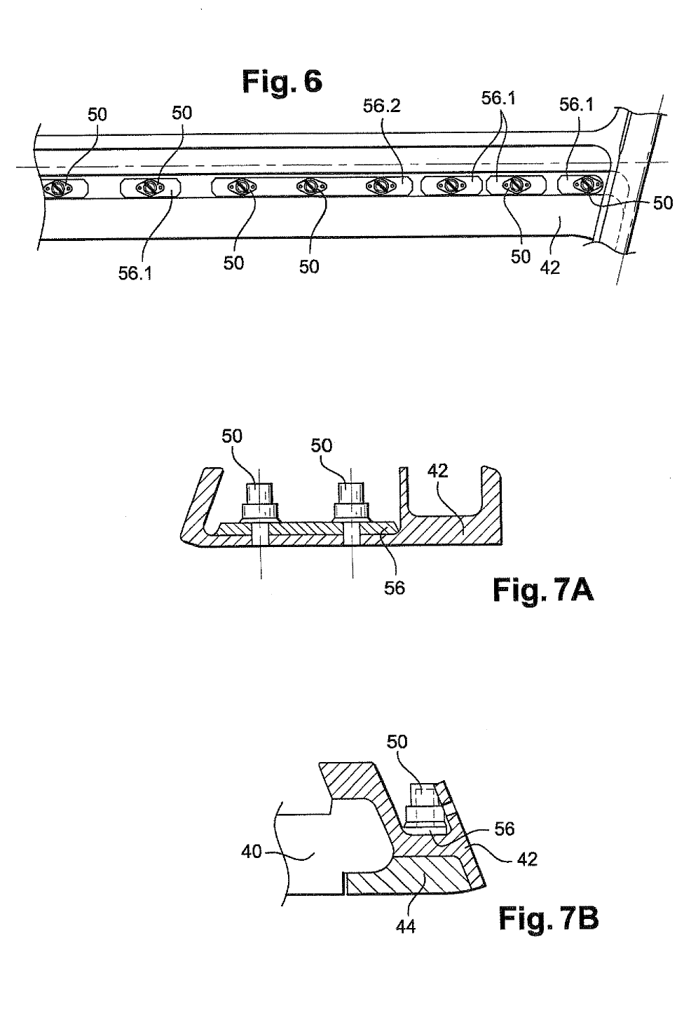

FIG. 6 is a top elevation view illustrating an example of how the nuts are installed,

FIG. 7A is a cross-section illustrating an example of installation, and

FIG. 7B is a cross-section illustrating another example of installation.

FIG. 2 at 40 shows a glass of an aircraft windshield connected to the structure 42 of an aircraft by means of a frame or at least one flange 44 that is connected to said structure 42 by means of at least one connecting element 46, whereby the peripheral edges of said glass 40 of the windshield are interposed and clamped between the structure 42 and the flange 44. To ensure a reliable mounting, a number of connecting elements are distributed around the edges of the glass of the windshield. In addition, sealing means are generally provided around the edges of the windshield, interposed between the structure and the windshield and/or between the flanges and the windshield.

A connecting element 46 comprises a screw 48 as well as a nut 50, whereby the assembled holding elements (structure/flange(s)) are interposed between the head of the screw and the nut.

Each screw 48 passes through the flange 44 and the structure 42, whereby the head rests against the outside surface of the flange 44 and is placed inside a housing 52 that is provided at the outer surface of said flange. A plug or cap 54 is provided to close said housing 52 and to limit disruptions of the air flows at the surface of the aircraft fuselage and to not allow the infiltration of water.

The structure, the flanges, as well as the sealing means are not presented in more detail because they are known to one skilled in the art and vary from one aircraft model to the next.

According to the variants, the head of the screw 18 may have various outer shapes and/or patterns that make it possible to manipulate it. Even if the description is made with a screw with a hexagonal head, the invention is in no way limited to this type of screw.

Likewise, the shapes of the housing 52 and, consequently, the plug 54, are suitable in particular for the head of the screw to facilitate the manipulating of said head.

According to the variants, the screw 48 can comprise means for preventing its unscrewing at the head, such as, for example, a split washer. Likewise, the nuts 50 can be elastic stop nuts.

Advantageously, the attachment device also comprises screws 48 and nuts 50, at least one small nut-support plate 56 that can be inserted between at least one nut 50 and the structure 42.

A small nut-support plate 56.1 can support a nut 50 as illustrated in FIGS. 6 and 7B. As a variant, a small nut-support plate 56.2 can support several nuts 50 as illustrated in FIGS. 6 and 7A.

The small nut-support plates 56 are made integral with the structure 42 by any suitable means, in particular by means of at least one rivet 58.

A small nut-support plate 56 makes it possible to obtain a better distribution of the tightening forces on the structure and to limit the anchoring points on said structure, whereby the small plate generally supports several nuts 50.

The shapes, the sizes, and the number of small plates are determined by one skilled in the art. These small plates are not presented in more detail because they are known. In general, the access to the nuts 50 is limited in particular because of the complex shapes of the structure that on this level comprises numerous reinforcements and the complex environment inside the cockpit of an aircraft.

Consequently, the nuts 50 are made integral with the structure 42 directly or indirectly by means of a small plate 56 to prevent said nuts from rotating when the screws 48 are screwed and to make it possible to tighten said screws 18. This connection also makes it possible to prevent the unscrewing of the nuts because of in particular, vibrations.

According to the invention, the nut 50 comprises two parts, a first part 60, below, that is called body and that comprises a threaded bore 62 that can work with the threaded stem of a screw 48, and a second part 64, below, that is called base and that can be made integral with the structure 42, whereby the body 60 and the base have cooperating shapes that make it possible to prevent the body 60 from rotating relative to the base 64 along the axis 66 of the bore 62. According to one embodiment, the base 64 is connected to the structure or to a small nut-support plate by means of at least one rivet 68, preferably two rivets that are placed in a diametrically opposite manner.

Preferably, the body 60 comprises a recessed threaded bore 62. This characteristic makes it possible to limit the risks of damage of the nut because of the corrosion between the nut and the threaded stem of the screw.

According to an embodiment that is illustrated in the various figures, the body comprises an essentially cylindrical outer shape with graduated diameters that are approximately coaxial to the axis 66.

At one of its ends, the body 60 comprises a surface 70 that can be in contact with the base 64, whereby said surface is approximately perpendicular to the axis 66.

To prevent the body from rotating relative to the base along axis 66, the surface 70 comprises at least one protuberance 72 that projects relative to said surface 70 along the axis 66 of the bore that can work with a pattern 74 that is provided at the base 64.

According to the invention, the protuberance 72 has a section that is lower than the support surface 70, which makes it possible to obtain a more compact nut.

Thus, the base comprises a support surface against which the surface 70 can rest with a recessed shape that corresponds to the pattern 74 in which the protuberance 72 can be housed.

Advantageously, the body 60 comprises a protuberance 70 that is centered relative to the axis 66 that forms a shoulder whose peripheral shapes are adjusted to those of the pattern 74 that is provided at the base 64.

According to one embodiment, the protuberance 72 and the pattern have a square peripheral shape with rounded angles, as illustrated in FIGS. 4 and 5. Preferably, the base 64 comes in the form of a plate that comprises the pattern 74. According to the variants, the pattern 74 can have a section that is identical over the entire height of the base as illustrated in FIG. 5 or can comprise a shoulder with a small section that makes possible, however, the passage of the threaded stem.

The base 64 comprises two wings 76 that are arranged on both sides of the pattern 64 with passage holes 78 provided for the rivets 68.

According to another characteristic of the invention, sealing means 80 are provided between the body 60 and the base 64. According to one embodiment, the surface 70 of the body 60 comprises a peripheral groove 82 that surrounds the protuberance 72, whereby the groove 82 is able to house a seal, in particular an O-ring seal.

This characteristic makes it possible to improve the scaling and to prevent the corrosion between the threaded stem of the screw 48 and the nut 50.

According to another characteristic of the invention, the nut 50 comprises means that make it possible to limit the translational motions of the body 60 relative to the base 64 in the direction that is defined by the axis 66. For this purpose, the nut 50 comprises an arch 84 whose ends are connected to the base 64 at two points that are diametrically opposite relative to the pattern 74. The arch 84 is able to occupy a first position in which it extends into a plane that is approximately perpendicular to the base 64, as illustrated in FIG. 3, so as to immobilize the body 60, and another position in which it is inclined and no longer holds the body 60.

This characteristic makes it possible to facilitate the mounting, whereby the body of the nut is held in place using the arch 84 itself if said body has a tendency to fall because of its own weight.

According to one embodiment, the base 64 comprises two lugs 86 that are bent back diametrically opposite relative to the pattern, each with a hole 88 that can accommodate a bent-back end of the corresponding arch 84. This solution makes it possible to obtain a simple connection between the arch and the base.

During the initial mounting, the base of the nut 50 is made integral with the structure 42, either directly or by means of a small nut-support plate 56 that is connected to the structure by rivets 58, whereby the base 64 is connected to the small nut-support plate by means of rivets 68. Next, the body 60 of the nut is placed on the base 64 and held using the arch 84.

The glass 10 of the windshield that is equipped with sealing means is then placed in the frame that is provided in the structure 42, then the flange or flanges 44 are placed around the edges of the glass 10. Next, the screws 48 are screwed into the riveted nuts 50. For this purpose, the head of the screw is manipulated by any suitable means, such as, for example, a key.

The attachment device that comprises the screw and the nut makes it possible to obtain a reliable connection because the protuberance 72 of the body is held in the pattern 74 using the force that is exerted by the screw 48 on the body 60 and prevents said body from rotating relative to the base 64, which is itself immobilized relative to the structure. According to the invention, the risks of corrosion between the threaded stem of the screw 48 and the nut 50 are limited due to sealing means 80 and the recessed bore 62.

In contrast to the nuts of the prior art, the nut of the invention makes possible a very rapid change of said nut because it comprises two parties, whereby only the party that is not tied to the structure is able to be changed in the case of deteriorations.

Thus, it is enough to move the arch 84 to change the body 60. The base 64 always remains integral with the structure or the small nut-support plate although it is no longer necessary to remove the entire nut and the small plate to reassemble the unit by riveting, on the one hand, said small plate onto the structure and, on the other hand, the nut onto the small nut-support plate.

Thus, using the nut of the invention, changing the windshield is facilitated and can be performed in a small period of time, limiting the downtime of the aircraft. As a variant, the mounting could be reversed, whereby the nut is connected to the flange 44 and the head of the screw can rest against the structure 46.

1. Nut for the attachment of an aircraft windshield (40) that is interposed between two elements (42, 44) that are kept assembled by at least one connecting element (46) that comprises a screw (48) and said nut (50), whereby said nut (50) comprises two parts, a first part (60) that is called a body that comprises a threaded bore (62) that can work with the threaded stem of the screw (48), and a second part (64) that is called a base that can be integrated with one of the windshield holding elements (42, 44), the body (60) and the base (64) having cooperating shapes that make it possible to prevent the body (60) from rotating relative to the base (64) along the axis (66) of the bore (62) of the body, characterized in that the body (60), at one of its ends, comprises a surface (70) that can be in contact with the base (64), whereby said surface (70) comprises at least one protuberance (72) that projects relative to said surface (70) in the direction of the axis (66) of the bore (62) that can work with a pattern (74) that is provided at the base (64).

2. Nut for the attachment of an aircraft windshield according to claim 1, wherein the body (60) comprises a protuberance (72) that is centered relative to the axis (66) whose peripheral shapes are adjusted to those of the pattern (74) that is provided at the base (64), whereby the protuberance (72) and the pattern (74) have a square peripheral shape with rounded angles.

3. Nut for the attachment of an aircraft windshield according to claim 1, wherein it comprises means (80) for sealing between the body (60) and the base (64).

4. Nut for the attachment of an aircraft windshield according to claim 3, wherein the surface (70) of the body (60) comprises a peripheral groove (82) that surrounds the protuberance (72), able to house a seal.

5. Nut for the attachment of an aircraft windshield according to claim 1, wherein it comprises means that make it possible to limit the translational motion of the body (60) relative to the base (64) in the direction that is defined by the axis (66).

6. Nut for the attachment of an aircraft windshield according to claim 5, wherein it comprises an arch whose ends are connected to the base (64), able to occupy a first position in which it extends in a plane that is approximately perpendicular to the base (64) so as to immobilize the body (60) and another position in which it is inclined and no longer holds the body (60).

7. Nut for the attachment of an aircraft windshield according to claim 6, wherein the base (64) comprises two diametrically opposite lugs (86) that are bent back, each with a hole (88) that can accommodate a bent-back end of the corresponding arch (84).

8. Nut for the attachment of an aircraft windshield according to claim 1, wherein the body (60) comprises a recessed threaded bore (62).

9. Device for attaching a windshield (40) of an aircraft that comprises a structure (42), whereby said windshield (40) is interposed between said structure (42) and at least one flange (44) that are kept assembled by at least one attachment element that comprises a screw (48) and a nut according to claim 1.

10. Device for attaching an aircraft windshield according to claim 9, wherein it comprises at least one small nut-support plate (56) that is interposed between the structure (42) and the base (64) of the nut.
